(19) United States
(12) Patent Application Publication
(10) Pub. No.: US 2008/0224348 A1
(43) Pub. Date: Sep. 18, 2008

(54) PRESS-MOLDING APPARATUS AND WORK-CONVEYING METHOD IN THE APPARATUS

(75) Inventor: Satoshi OHGAMI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 12/128,288

(22) Filed: May 28, 2008

Related U.S. Application Data
(63) Continuation of application No. PCT/JP2006/323481, filed on Nov. 24, 2006.

(30) Foreign Application Priority Data
Nov. 28, 2005 (JP) 2005-342659

(51) Int. Cl. B29C 43/52

(52) U.S. Cl. 264/238; 425/161

(57) ABSTRACT

There are provided a press-molding apparatus and a work-conveying method, which are capable of restraining oxygen from entering the molding apparatus when a work, such as a mold or a material, is carried into the molding apparatus.

In a press-molding apparatus comprising a heating section, a molding section and a cooling section, each of the sections including an inlet and an outlet for a work, each of the inlet and the outlet is provided with a door, which has a restoring force and is capable of being push-opened, whereby a work is conveyed, push-opening the door.

### TECHNICAL FIELD

The present invention relates to a press-molding apparatus for press-molding an optical element, such as a glass lens, to be used for an optical instrument, and a work-conveying method in the apparatus.

### BACKGROUND ART

Heretofore, a molding method has been widely implemented for producing an optical element comprising a glass lens by press-molding a heated and softened glass material. Specifically, a glass material, which has been preliminarily molded into, e.g., a spherical shape, is set in a mold comprising a top mold, a bottom mold and a body mold, the glass material is softened by being heated to a temperature of about 500 to about 600° C. in a heating step, and the softened glass material is pressurized to be molded into a lens product and is cooled, followed by being taken, as a final product, out of the mold.

Since, particularly, the molding step among these steps is carried out at a high temperature, the oxidation of the mold and a mold protection film is developed to make the life of the mold short when the molding step is carried out in air, which contains oxygen. In particular, the molding surface of the mold, which is relevant to the formation of the optical surface of a lens, is formed as a mirror surface having high precision, and the molding surface is usually coated with a protection film. If the molding surface is oxidized, the molding surface is made rough, which adversely affects the transmittance and the molding precision of a lens to be molded. In some cases, the mold surface or the surface of a glass material reacts with oxygen in air to form oxides thereon, and such oxides firmly adhere thereto because of reacting with one another during press-molding, with the result that a molded product is broken or a molded product cannot be released from the mold because of adhering to the mold. If a molded product that has been adhered to the mold is forcibly released, a portion of the glass material remains on the mold. In order to remove such a remaining portion without damaging the mirror surface of the mold, it is necessary to carry out treatment, such as careful polishing by alumina powder, or dissolution of glass by a solution, which comprises fluorinated acid or ammonium fluoride. If the mold is inadvertently damaged during such treatment, it is necessary to redeposit a protection film on the molding surface, which takes a lot of trouble and is costly. If the mold is oxidized, the resistance at the sliding portions of the top mold and the body mold increases. As a result, stable mass production is made impossible since the molding take time increases or the molding condition needs to be changed.

In order to avoid the occurrence of such inconvenience, the molding apparatus that is operated at a high temperature needs to keep a non-oxidizing atmosphere containing no oxygen therein, being filled with a non-oxidizing gas, such as a nitrogen gas or argon gas.

Heretofore, in order to prevent oxygen from entering in the molding apparatus in the heating step, the press-molding step and the cooling step when a mold with the material for an optical element or a material set therein is conveyed into the molding apparatus, the entire molding apparatus is put in an airtight state, or the is molding apparatus is provided with shutters at the inlets and the outlets of the respective steps.

For example, patent document 1 discloses a molding apparatus, which sequentially conveys a mold to a heating section, a molding section and a cooling section. This molding apparatus includes a heat-shielding shutter plate between adjacent sections. The entire sections are disposed in a housing in a non-oxidizing atmosphere, and the heat-shielding shutter plates are disposed for the purpose of preventing heat from escaping from the respective sections. However, when a shutter plate is opened and closed, a relatively large amount of air or gas flows through the opened shutter plate, with the result that heat also escapes along with such air or gas.

Patent document 2 discloses a molding apparatus, wherein a mold is disposed in a molding chamber, and the material for an optical element is conveyed into the molding chamber. This molding apparatus has shutters disposed at both ends of the molding chamber. In this case as well, when a shutter plate is opened and closed, a relatively large amount of air or gas enters through an opened shutter, with the result that the oxygen concentration in the chamber significantly increases.

FIGS. 6(A) to (C) are schematic views sequentially showing how a work 53, such as a mold or a material, passes through an opening section 50 with a shutter 52 disposed thereat. Views (a) and (b) in each of FIGS. 6(A) to (C) are a plan view and a front view.

As shown in FIG. 6(A), the work 53 is conveyed in the direction indicated by the arrow. When, e.g., a sensor detects that the work has arrived at a position just before the shutter 52, the shutter 52 is lifted as shown in FIG. 6(B). After the shutter 52 has been fully opened, the work 53 passes through the opening section 50. At this time, the entire opening section is opened outside as shown in FIG. 6(B) (b). After the entire work 53 has entered a chamber 51, the shutter 52 is closed as shown in FIG. 6(C). In this way, the entire opening section 50 is opened outside throughout the period in which the work 53 is passing through the opening section 50. During this period, an oxidizing gas, such air, enters in the molding chamber through the opening section 50 to increase the oxygen concentration in the chamber 51.

Although a heating section, which is at the highest temperature, is disposed in a deep position of the molding apparatus according to patent document 2, it is impossible to prevent such an oxidizing gas from entering through the opening section in a large amount when such a work is carried in and out. For this reason, a non-oxidizing atmosphere is kept by supplying a large amount of nitrogen gas while taking much time to exchange gasses. This treatment needs a large amount of nitrogen gas and takes much time to exchange gases, with the result that the treatment is costly and lowers productivity.

In order to decrease the amount of oxygen that enters in the molding apparatus when the shutter is opened as stated above, an anterior chamber is disposed at each of the front end and the rear end of the molding apparatus in some cases. In other words, the entrance door of the anterior chamber is first opened, a work is carried into the anterior chamber, and the entrance door of the anterior chamber is closed, followed by opening the entrance door of a section, such as a heating section, to carry the work thereinto. This method can decrease the inflow rate of oxygen since the heating chamber is not opened directly outside. However, oxygen enters in the anterior chamber when the entrance door of the anterior chamber is opened. When the entrance door of the heating chamber is opened, the heating chamber fails to sufficiently keep a non-oxidizing atmosphere therein since the oxygen that has entered in the anterior chamber enters the heating chamber. Furthermore, the entire apparatus is made larger since a space for the anterior chamber is needed.

Patent document 1: JP-A-3-55417

Patent document 2: JP-A-8-188421

### DISCLOSURE OF THE INVENTION

### Problems to be Solved by the Invention

The present invention is proposed, taking the above-mentioned prior art into account. It is an object of the present invention to provide a press-molding apparatus and a work-conveying method, which are capable of restraining oxygen from entering the molding apparatus when a work, such as a mold or a material, is carried into the molding apparatus.

### Means for Solving the Problems

The present invention provides a press-molding apparatus comprising a heating section, a molding section and a cooling section, each of the sections including an inlet and an outlet for a work, wherein each of the inlet and the outlet is provided with a door, which has a restoring force and is capable of being push-opened (hereinbelow, referred to as the press-molding apparatus according to the present invention).

In the press-molding apparatus according to the present invention, it is preferred that the door comprise double doors.

In the press-molding apparatus according to the present invention, it is preferred that the door have at least an openable side divided into a plurality of sections.

In the press-molding apparatus according to the present invention, it is preferred that each of the inlet and the outlet have a partition wall having an opening section therein, and that the door be mounted to a portion of the partition wall on a peripheral portion of the opening section.

The present invention also provides a work-conveying method in the press-molding apparatus according to the present invention, which is performed at each of the inlet and the outlet for a work, the inlet and the outlet being disposed at each of the heating section, the molding section and the cooling section included in the press-molding apparatus; comprising disposing a door at each of the inlet and the outlet, the door having a restoring force and being capable of being push-opened, whereby the work is passing through the door, push-opening the door.

### EFFECTS OF THE INVENTION

In accordance with the present invention, since the door, which has a restoring force and is capable of being push-opened, is disposed, the door is push-opened so as to correspond to the width or the height of a work when the work is passing therethrough, and the door is immediately closed by the restoring force when the work have passed therethrough. As a result, the required opening is minimized, and the opening period can be reduced to the minimum. Accordingly, it is possible to significantly reduce the inflow rate of an oxidizing gas and to keep the oxygen concentration in the molding apparatus at a low level. Since the life of a mold and a mold protection film can be extended to reduce the frequency of maintenance by restraining the mold from being oxidized accordingly, it is possible to cut costs, such as mold cost or labor cost.

Furthermore, the door, which is capable of being push-opened, has a simple structure and can be easily mounted. Accordingly, the shutter of a conventionally utilized molding apparatus can be replaced by the door according to the present invention.

When the door comprises double doors in the present invention, the doors are opened on both sides by the width of a work, with the result that the area of the useless opened portions on the right and left sides of the work is minimized in comparison with a single swing door. Accordingly, the width of the opening can be minimized, restraining an oxidizing gas from entering. Furthermore, since each of the right and left doors has a smaller width than a single swing door, the time period required for opening and closing the door can be reduced, restraining an oxidizing gas from entering when opening and closing the door.

When the door has an openable side divided into a plurality of sections, the formation of useless openings can be minimized in vertical and lateral directions, and the opening is formed only by a minimized area that correspond to the size of a work. As a result, since the size of the opening is further reduced, the opening allows the work to pass therethrough with the size of the opening minimized, restraining an oxidizing gas from entering. The door may be divided into plural sections along the entire length thereof from the openable side to the pivotal side thereof.

When the door is mounted to a portion of the wall on a peripheral portion of an opening section, the door can be closed, being brought into close surface contact with the wall without gaps, preventing an oxidizing gas from entering through a gap.

In accordance with the present invention, the door can be push-opened by a work, and the door is closed by the restoring force after the work has passed therethrough. This arrangement can eliminate a sensor for a work or a driving force for opening and closing the door, which reduces the costs for installation and operation. Accordingly, it is possible to significantly reduce the total cost required for producing an optical element.

### BRIEF DESCRIPTION OF DRAWINGS

FIG. 1 contains schematic views showing an embodiment of the present invention;

FIG. 2 is a vertical cross-sectional view showing an example of a work;

FIG. 3 contains schematic views showing a different embodiment of the present invention;

FIG. 4 contains plan views showing another different embodiment of the present invention;

FIG. 5 contains schematic views showing the operation of the embodiment shown in FIG. 4(A); and

FIG. 6 contains schematic views showing prior art.

### EXPLANATION OF NUMERALS

2, 4 and 5: door, 3 and 6: work, 7: jig for conveyance, 10: opening section, 11: inlet, 12: chamber, 13: partition wall, 14: recession, 15: abutting portion, 20: opening, 31: mold, 31a: top mold, 31b: bottom mold, 31c: body mold, 32: cover, 50: opening section, 51 chamber, 52; shutter, 53: work

### BEST MODE FOR CARRYING OUT THE INVENTION

In the molding apparatus for molding an optical element, such as a glass lens, according to the present invention, a material or a molded product is conveyed to respective sections for a heating step, a molding step and a cooling step, being housed in a mold or being taken out of a mold and put on, e.g. a holder. In the heating step, the mold or the material is heated to such a temperature that the glass material is softened so as to be capable of being press-molded. In the molding step, the material is molded as a product having desired dimensions by being pressed while the material is continuously heated, as required, so that the temperature of the heated material is prevented lowering. In the is cooling step, the molded product is cooled to such a proper temperature that the quality of the molded product is stabilized.

In the above-mentioned molding apparatus, the push door according to the present invention is disposed at each of an inlet and an outlet for taking a work, such as a mold or a holder, in and out.

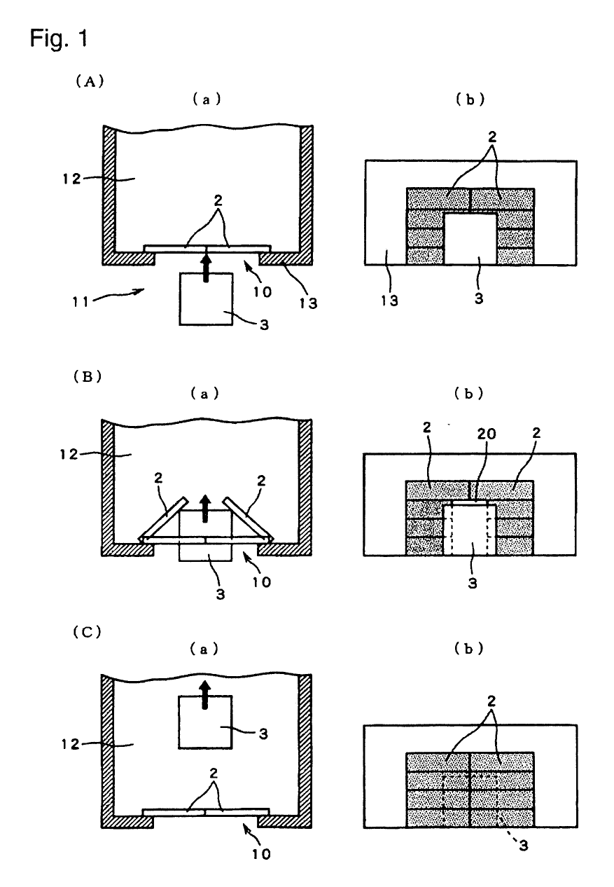

FIG. 1 shows an embodiment of the present invention. Views (a) are plan views seen from above, and views (b) are front views. FIG. 1(A) shows how a work 3 is moving toward an inlet 11, FIG. 1(B) shows how the work 3 pushes and open a door 2, and FIG. 1(C) shows how the work 3 has passed through the door 2.

The door 2 comprises double doors, which are divided into right and left doors from the center of an opening section 10 and are openable toward a chamber 12 in the molding apparatus. The chamber 12 is, e.g., a heating section of the molding apparatus. As shown in views (b), the door 2 is divided into a plurality of sections, such as four sections, in the vertical direction, and one end of each section of the door 2 is mounted on the side of the chamber 12 of a partition wall 13 through a hinge (not shown). The mounting portions comprising such hinges are disposed on a peripheral portion of the opening section 10 on the side of the chamber so as to prevent an oxidizing gas from entering through a gap of the mounting portions. The door 2 is made of a material, which is excellent in airtightness and heat resistance, such as iron or stainless steel. The door 2 has a restoring force. The restoring force may be obtained by combining restoring springs with the hinges. Or, spring materials for restoring may be coupled to the door 2.

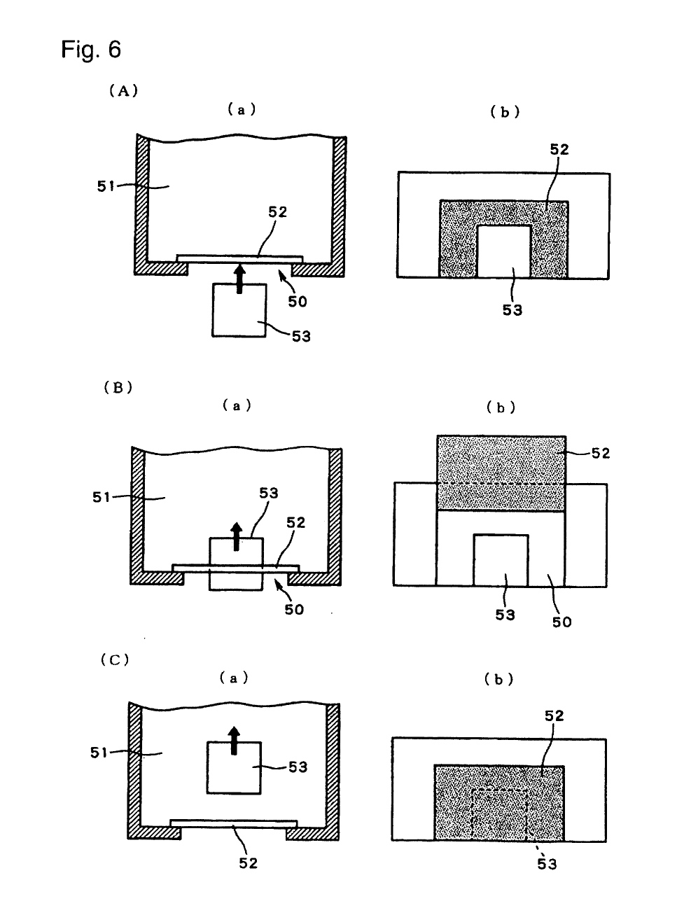

As shown in FIG. 1(A) (a), the work 3 is conveyed in the direction indicated by the arrow. When the work is brought close to the inlet and is brought into contact with the door 2, the door 2 is push-opened by the work 3 as shown in FIG. 1(B) (a). At this time, the sections of the door, which correspond to the size of the work 3 in the height direction, for example, the sections of the door positioned at lower three stages, are push-opened as shown in FIG. 1(B) (b). Accordingly, if the work 3 to be conveyed has a small size in the height direction, the door is prevented from being opened so as to form an opening having an unnecessary area in the vertical direction, and only an opening 20 is formed to be opened outside, having a small necessary area. Thus, the inflow rate of an oxidizing gas can be significantly reduced in comparison with the case of the above-mentioned shutter 52 shown in FIG. 6. When the mating end portions of the doors, at which the doors are divided along the vertical center, are configured to be overlapped, it is possible to increase airtightness.

When the work 3 has passed through the door 2, the door 2 is immediately closed by the restoring force given by the hinges or the spring member of the door 2 as shown in FIG. 1(C). Accordingly, the time period where the opening 20 formed in the opening section 10 is opened outward is extremely short.

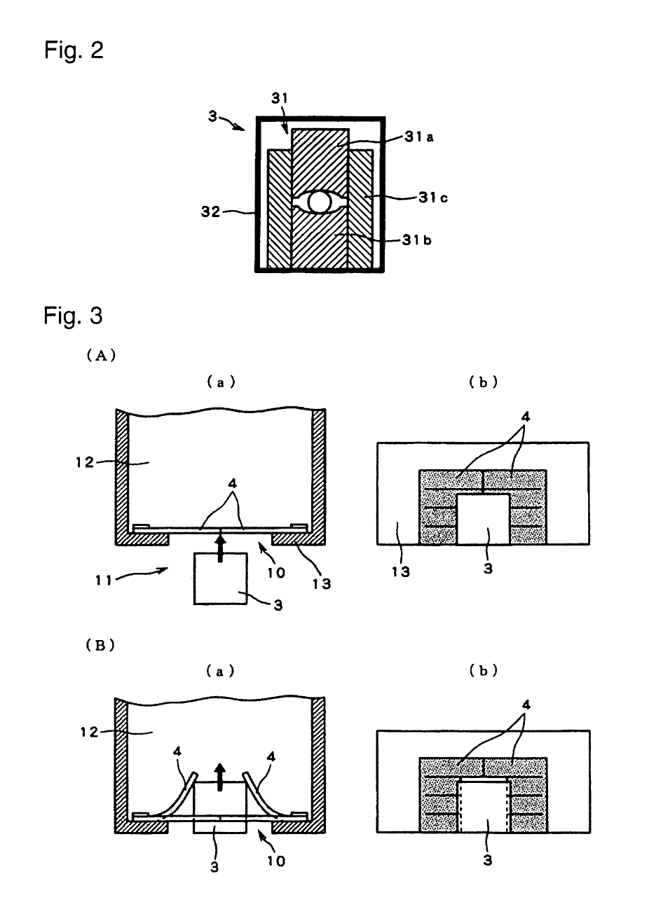

FIG. 2 shows an example of the work 3 in a case where a mold 31 comprising a top mold 31a, a bottom mold 31b and a body mold 31c is conveyed. The mold 31 has the top end of the top mold 31a positioned at a higher level than the top end of the body mold 31c before molding as shown in this figure. If the door is push-opened while the mold keeps such a shape, an unnecessary open section is formed above the upper portion of the body mold 31c at the push-opening time, and the opening area increases, facilitating the inflow of an oxidizing gas. In such a case, the mold 31 may be conveyed, being covered with a cylindrical or rectangular parallelepiped cover 32 so as to eliminate a stepped portion or a recessed portion on the outer peripheral surface of the mold (work), providing the work with a simple linear cross-sectional shape. By this arrangement, the opening area, which is formed when the door is push-opened, can be decreased to reduce the inflow of an oxidizing gas. Even in a case where the opening area is large because the work has such a complex shape that the work fails to effectively push-open the end portions of the door, or a case where the work is prevented from being brought into direct contact with the door to be damaged, it is effective that the work is conveyed, being covered with such a cover 32.

FIG. 3 shows a different embodiment of the present invention, wherein the door per se is made of a material having a restoring force, such as a thin metal plate having heat resistance. Views (a) are plan view seen from above, and views (b) are front views. FIG. 3(A) shows how the work 3 is moving toward the inlet 11, and FIG. 3(B) shows how the work push-opens the door 4.

The door 4, which comprises double doors, is configured so that free end portions on door opening sides are vertically divided into plural sections, and the door 4 has pivotal end portions fixed to the partition wall 13 on the side of the chamber 12 as shown in views (b). In this embodiment, although the door 4 is fixed at the pivotal end portions, the free end portions of divided sections are flexed along the work 3 to open the door when the door is pushed by the work 13. This embodiment has a simple structure because of having no need of disposing movable portions, such as hinges. Furthermore, this embodiment can keep the airtight situation at a much higher level than the case where the movable portions are disposed at the pivotal end portions. It should be noted that even if the door per se has a restoring force, the door may be mounted by using hinges.

In this embodiment, the door 4 per se is flexed. Accordingly, when the door is divided in the height direction, only the divided sections that are located at the stages corresponding to the size of the work 3 can be opened by laterally forming slits only in openable portions of the divided sections, without forming slits in the entire door 4 in lateral directions. When the door 4 is configured so that each of the right and left portions comprises a single portion having slits partially formed therein in such lateral directions as described above, the number of the mounting positions for the door 4 can be reduced, not only simplifying the mounting structure and the mounting operation but also increasing airtightness, in comparison with a case where the entire door is divided into four sections.

When the work 3 is conveyed in the direction indicated by the arrow as shown in FIG. 3(A) (a) and is brought into contact with the door 4, the door 4 is flexed to be push-opened toward the chamber 12 as shown in FIG. 1(B) (a). When the work 3 has passed through the door 4, keeping the door 4 open along the work 3, the door 4 is immediately closed by its own restoring force.

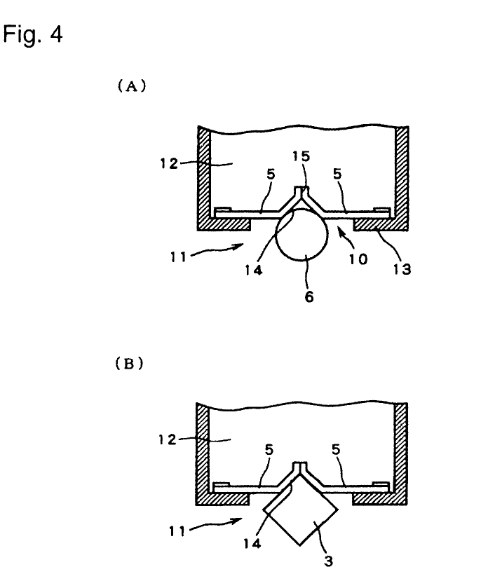

FIG. 4 shows another different embodiment of the present invention.

The door 5 comprises double doors, which are configured so that the free end portions of the right and left divided doors 5 and 5 are bent toward the chamber 12 so as to form a recession 14 when both divided doors are closed. For example, a work 6 formed in a cylindrical shape as shown in FIG. 4(A) is carried into the chamber 12, being positioned by the recession 14. When the work comprises a work 3 formed in a rectangular parallelepiped shape, the work can be positioned by being brought into contact with the recession 14 at a corner thereof as shown in FIG. 4(B). Although a work-positioning means, which is included in, e.g., a jig for conveyance, is usually required for conveyance, a work can be conveyed, being correctly positioned without providing the jig for conveyance 7 with a positioning function, by configuring the door 5 in the above-mentioned shape.

When the right and left doors 5 have abutting portions 15 formed at mating ends thereof so as to overlap with each other, it is possible to increase airtightness.

In this embodiment, the doors per se have a restoring force. As in the embodiment shown in FIG. 3, the right and left doors 5 have pivotal end portions fixed to a peripheral edge of the opening section 10 of the partition wall 13 on the side of the chamber 12.

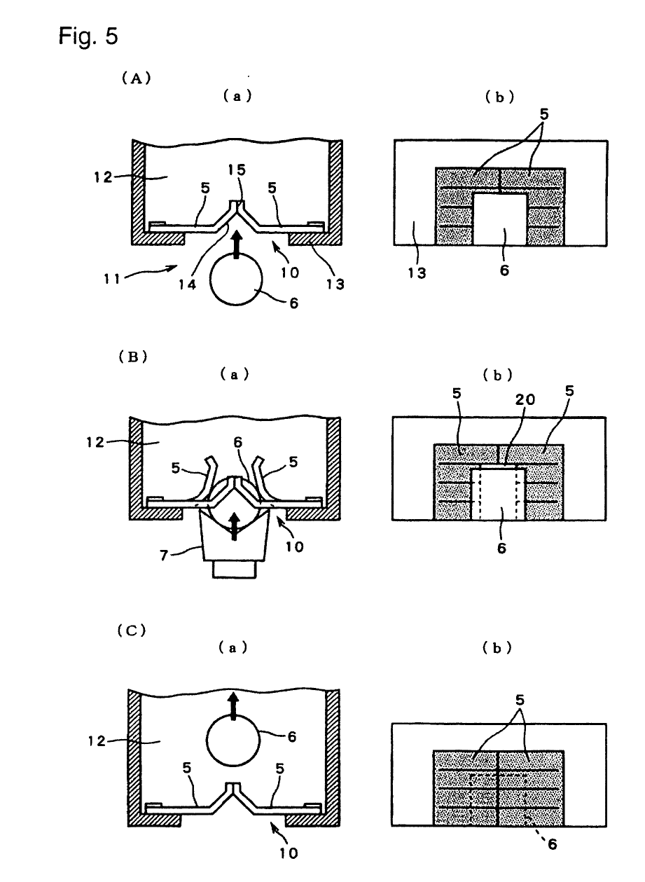

FIG. 5 shows an operation in the embodiment shown in FIG. 4(A). Views (a) are plan views seen from above, and views (b) are front views. FIG. 5(A) shows how the work 6 is moving toward the inlet 11, FIG. 5(B) shows how the work 6 push-opens the doors 5, and FIG. 5(C) shows how the work 6 has passed through the doors 5.

Each of the doors 5 is divided into a plurality of sections, e.g., four sections as shown in views (b), in the vertical direction. Each of the doors 5 have slits formed in a portion close to an openable end thereof. Thus, when the work 6 passes through the doors, only the sections that are located at stages corresponding to the size of the work 6 in the height direction are opened.

When, as shown in FIG. 5(A), the cylindrical work 6 is conveyed in the direction indicated by the arrow, is brought close to the inlet 11 and is brought into contact with the recession 14 of the doors 5, the work 6, which is pushed by the jig for conveyance 7, push-opens the doors 5 as shown in FIG. 5(B). At this time, the sections of the doors that correspond to the size of the work 6 in the height direction, such as the sections of the doors located at lower three stages, are push-opened. Thus, only the opening 20 is formed to be opened outside, having a small necessary area as shown in FIG. 5(B) (b). While the work 6 is passing through the opening section 10, the doors 5 are kept open along the work 6. When the work 6 has passed through the opening section, the doors 5 are immediately closed by their own restoring force as shown in FIG. 5(C).

In the embodiment shown in FIG. 4(A), the conveyance shown in FIG. 5 was made in a case where each of the doors 5, which was made of SUS316 stainless steel, had a thickness of 0.1 mm and had three slits formed therein so as to be divided in four sections in the vertical section, were mounted to the inlet 11, which had the opening section 10 formed therein so as to have dimensions of 40 mm×40 mm. The work 6 was formed in a cylindrical shape having a diameter of 30 mm and a length of 30 mm. The work was pushed toward the doors 5, being positioned by the jig for conveyance 7. This example revealed that the increase in the oxygen concentration during work-conveyance dropped to about 1/10 in comparison with a case where the entire opening section 10 was opened and closed by a shutter, and that the present invention was effective to reduce the oxygen concentration.

In each of the above-mentioned embodiments, it is preferred in terms of improving airtightness at the door closing time that the door be mounted to a portion of wall surface on a peripheral portion of the opening section so as to be apart from the opening section. When the right and left portions of double doors have mating edges overlapped with each other, it is possible to increase airtightness.

The door is not limited to be double doors as in the above-mentioned embodiment. The door may comprise a single swing door or a door capable of being opened upward. In the latter two cases, the work is conveyed at the right position, being positioned by, e.g. the jig for conveyance.

Although above-mentioned embodiments have been described about a case where the work is carried into the chamber 12 in a non-oxidizing atmosphere from an oxidizing atmosphere outside the chamber, the present invention is applicable to the reverse case in the same way.

The present invention is also applicable to the partition between adjacent ones among the heating, molding and cooling steps, which are disposed in an atmosphere of a non-oxidizing gas. In this case, the temperature in one of the steps can be difficult to effect another step.

### INDUSTRIAL APPLICABILITY

The present invention is applicable to a press-molding apparatus for a molded product, which includes heating, molding and cooling steps, and to a work-conveying method in the molding apparatus.

The entire disclosure of Japanese Patent Application No. 2005-342659 filed on Nov. 28, 2005 including specification, claims, drawings and summary is incorporated herein by reference in its entirety.

What is claimed is:

1. A press-molding apparatus comprising a heating section, a molding section and a cooling section, each of the sections including an inlet and an outlet for a work, wherein each of the inlet and the outlet is provided with a door, which has a restoring force and is capable of being push-opened.

2. The apparatus according to claim 1, wherein the door comprises double doors.

3. The apparatus according to claim 1, wherein the door has at least an openable side divided into a plurality of sections.

4. The apparatus according to claim 1, wherein the door is made of a metal plate having a restoring force and heat resistance, and the free end portion of an openable side of the metal plate is divided into a plurality of sections.

5. The apparatus according to claim 1, wherein each of the inlet and the outlet has a partition wall having an opening section therein, and the door is mounted to a portion of the partition wall on a peripheral portion of the opening section.

6. A work-conveying method in the press-molding apparatus defined in claim 1, which is performed at each of the inlet and the outlet for a work, the inlet and the outlet being disposed at each of the heating section, the molding section and the cooling section included in the press-molding apparatus;
comprising disposing a door at each of the inlet and the outlet, the door having a restoring force and being capable of being push-opened, whereby the work is passing through the door, push-opening the door.

7. The method according to claim 6, further comprising conveying the work while covering the work with a cover.
